(19) United States
(12) Patent Application Publication
(10) Pub. No.: US 2003/0126687 A1
(43) Pub. Date: Jul. 10, 2003

(54) Method for applying button to wire in telecommunication box

(76) Inventor: Timothy M. Crawley, Glendale, AZ (US)

Correspondence Address: Tod R. Nissle, Esq., TOD R. NISSLE, P.C., P.O. Box 55630, Phoenix, AZ, 85078, US

(21) Appl. No.: 10/047,416

(22) Filed: Jan. 10, 2002

(51) Int. Cl. B25F 1/00

(52) U.S. Cl. 7/107

(57) ABSTRACT

A tool and method are provide for applying a crimping device to a wire or wires in a telecommunication junction box. The method enables a single tool to be utilized to remove a wire from a wire bundle in a telecommunication junction box, cut the wire, place the wire in a crimping device, and crimp the crimping device onto the wire to establish an electrical connection with the wire.

This invention relates to methods and apparatus for manipulating the wiring in a telecommunication junction box having a plurality of wires and electrical connections.

More particularly, the invention relates to a method and apparatus for crimping a wire in a telecommunications junction box.

Telephone systems in the United States and other countries entail the use of relatively complex wiring. Telecommunication housings or junction boxes which contain many strands of telephone wires are placed in cities, towns and suburbs throughout the United States. Telephone company technicians open these junction boxes and connect, disconnect, crimp, and otherwise manipulate the wire housed in the boxes. Each wire typically includes an electrically insulative coating except at points along the wire which are stripped to expose the bare metal wire.

Telecommunication junction boxes have a variety of names, including cross box, ready access point, pedestal, SNI (standard network interface box on the sides of homes), demarcation point (typically in large buildings). Wires in the junction boxes typically are attached to binding posts, punch down blocks, screw terminals, or other electric terminals.

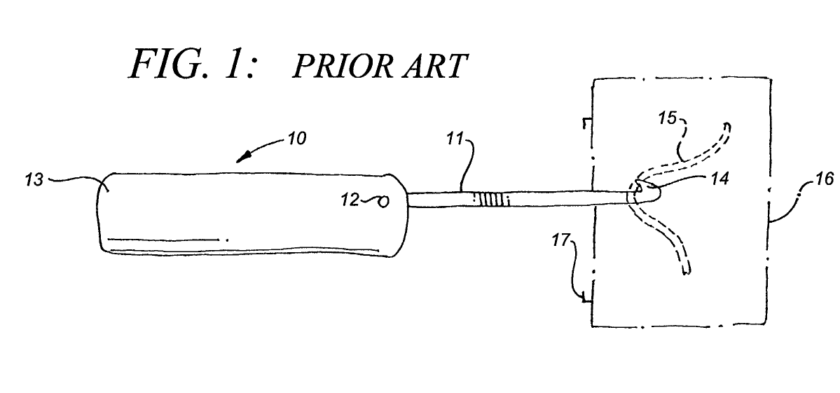

When a telephone company technician is accessing through a junction box door 17 a wire 15 in the junction box 16, he can use the tool 10 illustrated in FIG. 1. Tool 10 includes handle 13 and neck 11 pivotally attached to handle 13 by pin 12. The distal end of handle 11 includes hook 14. The technician uses hook 14 to engage wire 15 and pull wire 15 free from a bundle or group of other wires in box 16. Hook 14 may be utilized to pull a second wire (third wire, etc.) out from a bundle or group of wires. A wire cutter can be utilized to cut the wire 15 in half, if desired.

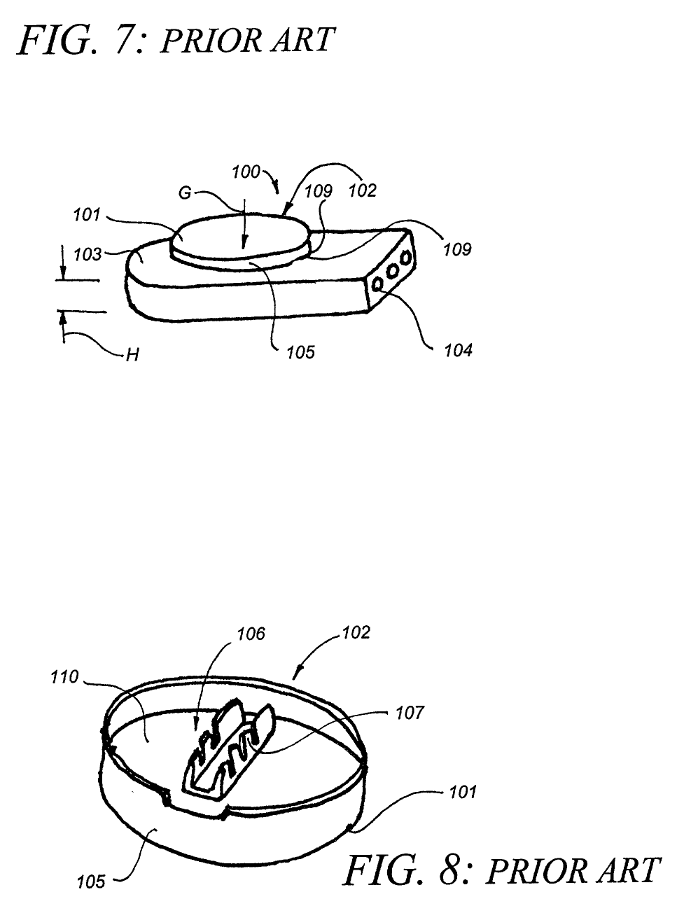

A “button” 100 (FIGS. 7 and 8) can be utilized to crimp or “splice” together two or more wires. Button 100 includes a cylindrical opening 109 which slidably receives cylindrical member 102. U-shaped metal member 106 includes rows of electrically conductive metal teeth 107. Member 106 is fixedly attached to inner surface 110 of member 102. Member 106 includes outer cylindrical wall 105 and circular upper surface 101. When surface 101 is depressed in the direction of arrow G, member 102 slides into cylindrical opening 109. If wire ends have been slidably inserted through cylindrical openings 104 so that the ends are positioned under member 102, then when member 102 is pressed into opening 109, teeth 107 penetrate the insulation covering the wire ends and contact and electrically interconnect the wires. A variety of crimping or splicing buttons are known in the art. By way of example, 3M Company produces various SKOTCHLOK (™) connectors which are used to splice together wires without having to strip off and remove the insulation from the wires at the points at which the wires are being spliced.

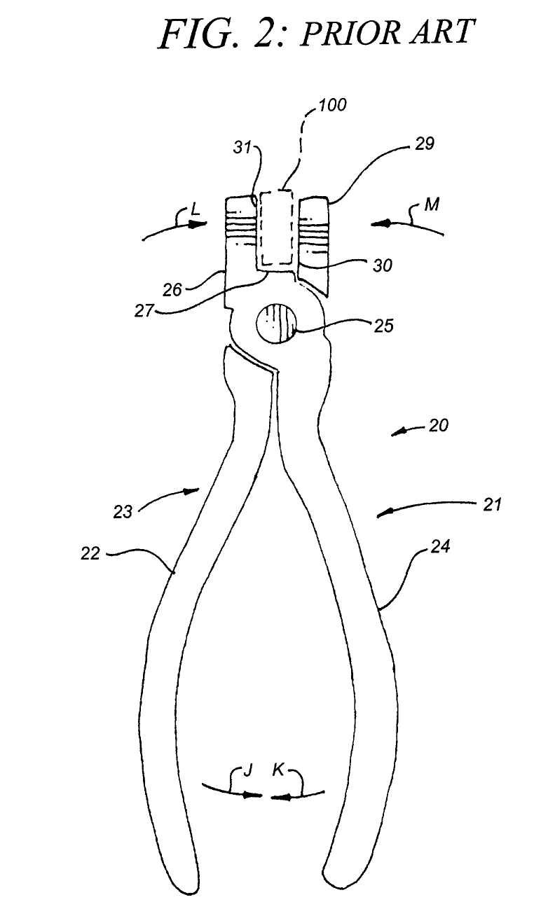

The tool 20 shown in FIG. 2 is typically used to squeeze, or crimp, member 102 after button 100 is inserted between gripping members 26 and 29 and handles 22 and 24 are manually displaced about pivot point 25 in the direction of arrows J and K to displace members 26 and 29 in the direction of arrows L and M to force member 102 in the direction of arrow G into opening 109 in housing 103. Button 100 rests against and is contacted by support surface 27, 30 and 31 when handles 22, 24 are manually displaced in the direction of arrows J and K to force member 102 into housing 103.

The foregoing procedure for manipulating wire in a telecommunication junction box has been used many times by telephone technicians. One disadvantage of the procedure is that it requires one tool 10 to remove a wire, requires another tool to cut the wire, and requires yet another tool 20 to crimp button 100 on a wire or wires. This requires a telephone technician to pick up, manipulate, and put down several tools while attempting to manually hold on to and manipulate one or more wires, a plurality of tools, and a crimping or splicing button 100. It would be highly desirable to provide an improved method and apparatus for crimping or splicing wires.

Therefore, it is a principal object of the instant invention to provide an improved method and apparatus for splicing or crimping wires in a telecommunication junction box.

These, and other and further and more specific objects of the invention, will be apparent to those skilled in the art based on the following description, taken in conjunction with the drawings, in which:

FIG. 1 is a side view illustrating a prior art tool for engaging and moving a wire in a telecommunication junction box;

FIG. 2 is a front elevation view illustrating a prior art tool for compressing a button used to splice or crimp wires;

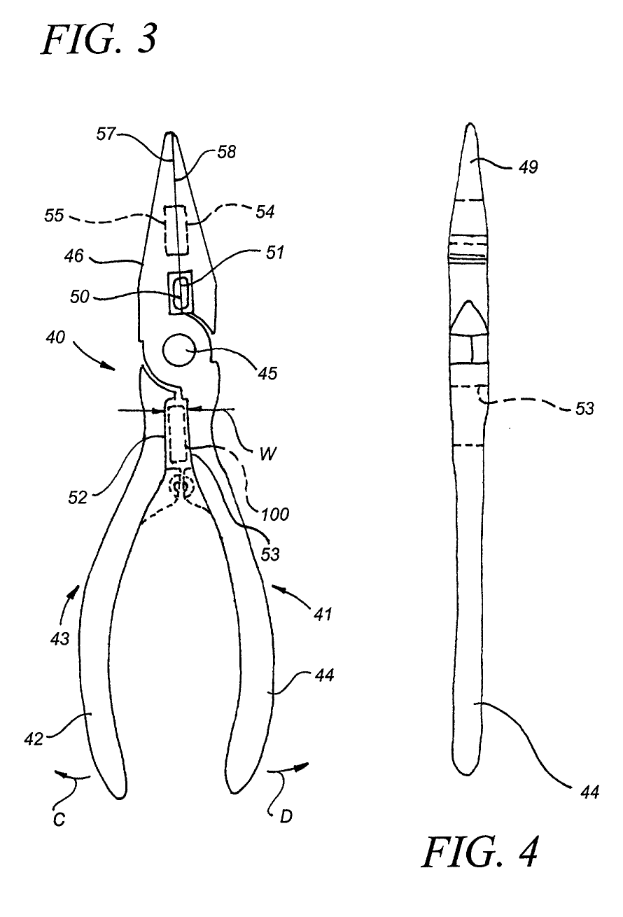

FIG. 3 is a front elevation view illustrating a tool constructed in accordance with the invention;

FIG. 4 is a side elevation view of the tool of FIG. 3;

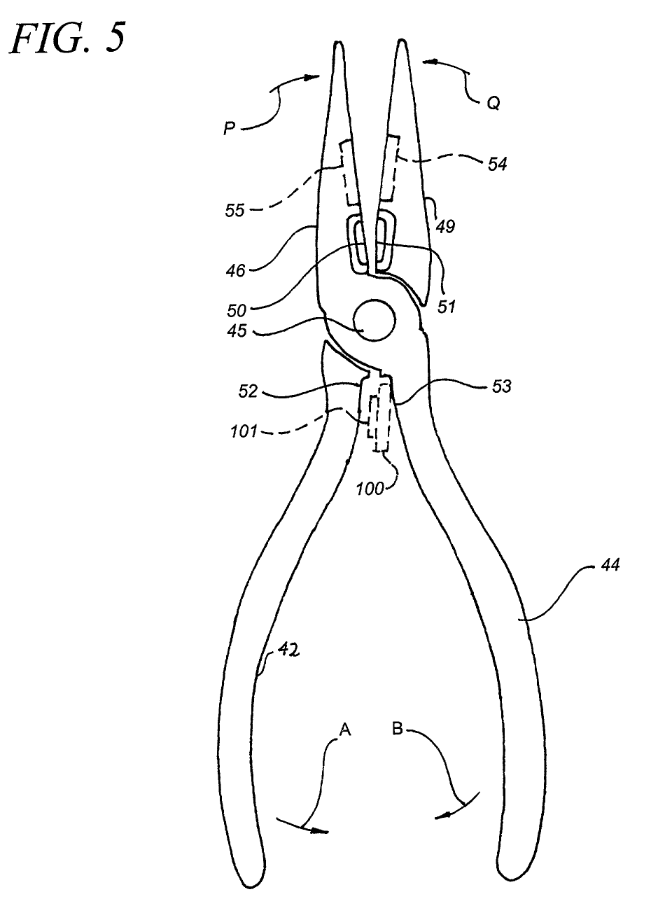

FIG. 5 is a front elevation view illustrating the mode of operation of the tool of the invention;

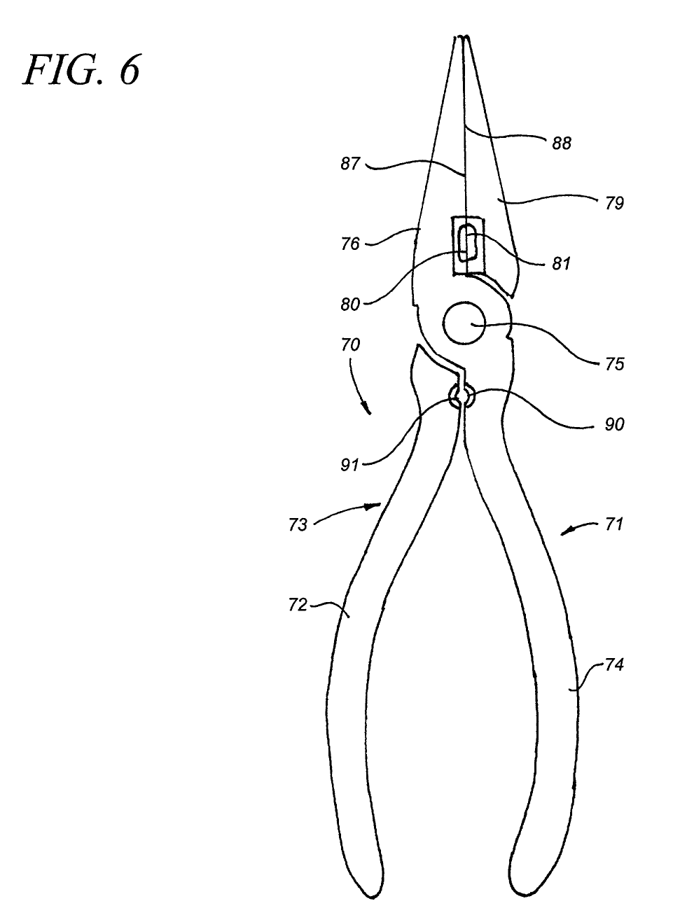

FIG. 6 is a front elevation view illustrating an alternate embodiment of the invention;

FIG. 7 is a perspective view illustrating a button used to crimp or splice wires; and

FIG. 8 is a perspective view illustrating a component of the button of FIG. 7.

Briefly, in accordance with the invention, I provide an improved method of crimping a wire in a hollow telecommunication junction box. The telecommunication junction box includes a door; a plurality of electrical connectors; and, a plurality of wires each connected to at least one electrical connector. The improved method includes the steps of providing a crimping button; and, providing a manually operated tool including a pair of components that are pivotally connected. Each component includes a handle at the distal end operatively opposed to the handle at the distal end of the other one of the pair of components; a needle nose gripping member at the proximate end operatively opposed to the needle nose gripping member at the proximate end of the other one of the pair of components; and, at least one crimp space formed therein. The method also includes the steps of opening the door to the telecommunication box; manually manipulating the tool to grasp a portion of at least one of the wires with the needle nose gripping members and displace the portion; placing a crimping button on the portion of the wire; and, manually manipulating the tool to grasp the crimping button in the crimp space of the tool and to compress the crimping button in the crimp space.

In another embodiment of the invention, I provide an improved tool including a pair of components pivotally connected. Each pair of components includes a handle at the distal end operatively opposed to the handle at the distal end of the other one of the pair of components; a needle nose gripping member at the proximate end operatively opposed to the needle nose gripping member at the proximate end of the other one of the pair of components; and, a cutting edge operatively opposed to the cutting edge on the other one of the pair of components. The tool also includes at least one crimp space formed therein shaped and dimensioned to receive and compress a crimp button.

Turning now to the drawings, which describe the presently preferred embodiments of the invention for the purpose of describing the operation and use thereof and not by way of limitation of the scope of the invention, and in which like reference characters refer to corresponding elements throughout the several views, FIGS. 3 to 5 illustrate a tool 40 constructed in accordance with the principles of the invention and including gripping needle-nose members 46 and 49 and handles 42 and 44. Handles 42 and 44 are manually displaced about pivot point 45 in the direction of arrows A and B to displace members 46 and 49 in the direction of arrows P and Q to force member 102 in the direction of arrow G into opening 109 in housing 103 when button 100 is placed between support surfaces 52 and 53 in handles 42 and 44. The distance W between support surfaces 52 and 53 is about equal to the width or height H (FIG. 7) of housing 103. As shown in FIG. 7, member 102 extends outwardly from housing 103 prior to button 100 being crimped. When button 100 is crimped, member 102 is driven into housing 103 in the direction of arrow G.

Needle nose members 46, 49 include gripping surfaces 57, 58 which typically, although not necessarily, are serrated. Member 41 includes member 46 and handle 44. Member 43 includes member 49 and handle 42.

A cutting edge 50, 51 is formed in each of members 46, 49. When members 46,49 are closed as illustrated in FIG. 3, edges 50, 51 oppose and contact one another. Edges 50 and 51 are used to cut a piece of wire by placing the wire between edges 50, 51 when members 46 and 49 are opened to the position shown in FIG. 5 and by then manually pressing handles 42 and 44 in the direction of arrows A and B to squeeze edges 50, 51 through the wire to cut the wire into two pieces.

If desired, an orthogonal opening for crimping a button 100 can be formed in members 46 and 49 at the location indicated by dashed lines 54, 55 by cutting out the portions of members 46 and 49 circumscribed by dashed lines 54, 55. The opening circumscribed by dashed lines 54, 55 would, when tool 40 was in the closed position illustrated in FIG. 3, have a shape and dimension comparable to that of the orthogonal opening which is formed in handles 42 and 44 and which includes opposing flat surfaces 52, 53. Surface 52 and 53 are generally parallel when handles 42 and 44 are in the closed position depicted in FIG. 3. The opening circumscribed by dashed lines 54, 55 would include opposing flat surfaces 52A, 53A. Surfaces 52A and 53A would preferably, but not necessarily, be generally parallel when handles 42 and 44 are in the position illustrated in FIG. 3.

Since the function of the crimping opening is, when a button 100 is positioned in the opening, compress member 102 in the direction of arrow G, it is understood that the shape and dimension of the crimping opening can vary, i.e. surfaces 52 and 53 need not necessarily be flat or be substantially parallel when handles 42 and 44 are in the closed position.

Tool 70 includes gripping needle-nose members 76 and 79 and handles 72 and 74. Handles 72 and 74 are manually displaced about pivot point 75 displace members 76 and 79. Cutting edges 80 and 81 are formed in members 76, 79, respectively. Semicircular edges 90 and 91 are formed in handles 74 and 72, respectively, and are used to strip insulation from wire. Pivotally connected members 71 and 73 each includes a member—handle pair. Member 71 includes member 76 and handle 74. Member 73 includes member 79 and handle 72.

In use, a telephone technician opens the door 17 to a telecommunication junction box; grasps tool 40; reaches inside the junction box with tool 40; maneuvers tool 40 to position a desired wire between members 57, 58 (this typically requires tapered members 46 and 49 to be pushed into a grouping or bundle of telephone wires, after which handles 42 and 44 are displaced in the direction of arrows C and D to slightly opening jaws or members 46 and 49); displaces handles 42 and 44 in the directions of arrows A and B to squeeze and grasp the wire 15 between members 57 and 58; pulls the tool 40 to pull the wire 15 to a desired location inside or outside of the junction box 16; grasps the wire 15 with one hand and uses the other hand to cuts one or more wires 15 with tool 40 by opening tool 40 by displacing handles 42 and 44 in the direction of arrows C and D, by placing the wire between cutting edges 50 and 51, and, by displacing handles 42 and 44 in the directions indicated by arrows A and B; grasps one end of the cut wire 15 and slips the end of the cut wire into an opening 104 in button 100 (or in another crimping or splicing device) so the end of the wire is positioned beneath member 102 (this is typically, but not necessarily, accomplished while holding the button 100 or end of wire 15 between members 46 and 49); opens with one hand handles 42 and 44 in the directions indicated by arrows C and D; places with another hand button 100 intermediate surfaces 52 and 53; and, displaces handles 42 and 44 in the directions indicated by arrows A and B to generate compressive forces G against member 102 which forces member 102 into aperture 105 and forces teeth 107 through the insulation in the end of the wire(s) positioned beneath member 102. Member 106 is shaped and dimensioned such that it extends over simultaneously and interconnects the ends of all three wires positioned beneath member 102 when a wire end is slid into each of the three (3) parallel cylindrical openings 104 extending into housing 105. Member 106 also interconnects the ends of any two wires slid into any two of the three openings 104. In FIG. 8, member 102 is upside down, i.e., is rotated 180 degrees from the orientation shown in FIG. 7. The method of the invention permits a telecommunications technician to find, position, cut, and splice a wire using a single tool.

The tapered configuration of members 46, 49 is important because the distal ends of members 46,49 must be able to slide into or pierce groups or bundles of wire to grasp a single wire in the bundle.

Tool 40 eliminates having to use tools 10 and 20 and, consequently, reduces the expense of equipping a telecommunications technician and reduces the time (i.e., the labor cost) associated with manipulating the telephone wires in a junction box.

Having described my invention in such terms as to enable those of skill in the art to understand and practice it, and having described the presently preferred embodiments and best mode thereof,

I claim:

1. A method of crimping a wire in a hollow telecommunication box including
a door,
a plurality of electrical connectors, and
a plurality of wires each connected to at least one electrical connector,
said method comprising the steps of
(a) providing a crimping button including
(i) a housing,
(ii) an opening formed in the housing,
(iii) a member mounted in said housing in a first operative position and displaceable to a second operative position,
(ii) an electrically conductive strip attached to said member to contact at least one wire in said housing when said member is displaced to said second operative position;
(b) providing a manually operated tool including a pair of components pivotally connected and each including
(i) a handle at the distal end operatively opposed to the handle at the distal end of the other one of said pair of components,
(ii) a needle nose gripping member at the proximate end operatively opposed to the needle nose gripping member at the proximate end of the other one of said pair of components,
the tool also including at least one crimp space formed therein;
(c) opening the door to the telecommunication box;
(d) manually manipulating said tool to reach into the telecommunication box and grasp a portion of at least one of said wires with said needle nose gripping members and displace said portion to a desired location;
(e) placing a crimping button on said portion of said wire; and
(f) manually manipulating said tool to grasp said crimping button in said crimp space of said tool and to compress said crimping button in said crimp space to move said member from said first to said second operative position.

2. A tool including a pair of components pivotally connected and each including
(a) a handle at the distal end operatively opposed to the handle at the distal end of the other one of said pair of components,
(b) a needle nose gripping member at the proximate end operatively opposed to the needle nose gripping member at the proximate end of the other one of said pair of components,
(c) a cutting edge operatively opposed to the cutting edge on the other one of said pair of components,
the tool also including at least one crimp space formed therein shaped and dimensioned to receive and compress a crimp button.
